(19) United States
(12) Patent Application Publication
(10) Pub. No.: US 2015/0139675 A1
(43) Pub. Date: May 21, 2015

(54) IMAGE FORMING APPARATUS

(71) Applicant: CANON KABUSHIKI KAISHA, Tokyo (JP)

(72) Inventor: Tomohiro Maruyoshi, Toride-shi (JP)

(21) Appl. No.: 14/538,655

(22) Filed: Nov. 11, 2014

(30) Foreign Application Priority Data
Nov. 15, 2013 (JP) 2013-236739

(51) Int. Cl. G03G 15/20

(52) U.S. Cl. CPC G03G 15/2039
USPC 399/68

(57) ABSTRACT

At least one embodiment of an image forming apparatus may include a transfer unit, a fixing unit, a motor configured to rotate a rotation member included in the fixing unit, a detection unit configured to detect the amount of bending of the sheet between the transfer unit and the fixing unit, an acquisition unit configured to acquire an average speed of the motor during conveyance of one sheet nipped by the rotation member, and a control unit configured to determine a speed of the motor for conveying a succeeding sheet by the rotation member based on the average speed acquired by the acquisition unit at a time when a preceding sheet is conveyed by the rotation member, and control the speed of the motor based on the amount of bending detected by the detection unit during driving of the motor based on the determined speed.

### BACKGROUND OF THE INVENTION

1. Field of the Invention

The present invention relates to control of a bending amount of a sheet conveyed to a fixing device.

2. Description of the Related Art

In an image forming apparatus, when thermal expansion of a fixing roller or a size error in manufacturing causes pulling of a transfer material or the excessive amount of bending, between the fixing device and a photosensitive drum, an image defect may occur. To prevent such an image defect, the fixing roller must be driven at an appropriate speed.

In Japanese Patent Application Laid-Open No. 5-107966, the fixing roller is driven at a first conveying speed lower than a conveying speed of the transfer material at a transfer unit and a second conveying speed higher than the first conveying speed. As a result, the bending (loop) occurs in the transfer material between the transfer unit and the fixing roller. When the amount of bending (also referred to as loop amount) generated in the transfer material is equal to or larger than a predetermined amount, the fixing roller conveys the transfer material at the second conveying speed. When the amount of bending is smaller than the predetermined amount, the fixing roller conveys the transfer material at the first conveying speed.

However, in the above-described conventional technology, when thermal expansion or thermal contraction of the fixing roller occurs, the first conveying speed and the second conveying speed fluctuate. Even when the fixing roller thermally expands due to a high temperature, the first conveying speed must be lower than the conveying speed at the transfer unit. Similarly, even when the fixing roller thermally contracts due to a low temperature, the second conveying speed must be higher than the conveying speed at the transfer unit.

Consequently, when the fixing roller is at a low temperature, a difference between the first conveying speed and the conveying speed at the transfer unit increases. As the speed difference is larger, the amount of bending generated in the transfer material per unit time is larger. Thus, the transfer material is likely to be excessively bent (an excess of bending) between the transfer unit and the fixing unit.

Similarly, when the fixing roller stands at a high temperature, a speed difference between the second conveying speed and the conveying speed at the transfer unit increases. As the speed difference becomes larger, the reduction amount of the bending per unit time becomes larger. Thus, the transfer material is likely to be pulled between the transfer unit and the fixing unit.

Thus, in the image forming apparatus configured such that the amount of bending which can be generated is limited, there is a possibility that an unfixed toner image is rubbed against a conveyance guide by an excess of bending, or image unevenness is caused by pulling of the transfer material. To increase the amount of bending which is generated, space between the fixing unit and the transfer unit must be widened. Consequently, it is difficult to miniaturize the image forming apparatus.

FIG. 7 is a diagram illustrating a relationship between a loop amount of the transfer material and a state of a loop sensor. FIGS. 8A to 8C are diagrams illustrating problems at the time when the fixing roller stands at the high temperature. A fixing loop sensor 162 is turned ON when the amount of bending is equal to or larger than a predetermined amount. The fixing loop sensor 162 is turned OFF when the amount of bending is smaller than the predetermined amount. A changing amount of bending per unit time increases when the fixing roller stands at the high temperature. Thus, the inclination amount of bending in a reduction direction (direction of an arrow D illustrated in FIG. 7) is steep. As a result, the amount of bending becomes 0 before the speed of the fixing motor decreases enough, thus the transfer material is pulled as indicated at a place E illustrated in FIG. 7. When the transfer material is pulled, an image density of the pulled part is reduced. Thus, the image density becomes periodically high and low, and the image has striped patterns.

### SUMMARY OF THE INVENTION

The present invention is directed to an image forming apparatus capable of stabilizing the amount of bending of a sheet between a transfer unit and a fixing unit.

According to an aspect of the present invention, an image forming apparatus includes a transfer unit configured to transfer a toner image to a sheet, a fixing unit including a rotation member and configured to convey the sheet to which the toner image has been transferred by the transfer unit in a state of being nipped by the rotation member and fix the toner image on the sheet, a motor configured to rotate the rotation member, a detection unit configured to detect the amount of bending of the sheet between the transfer unit and the fixing unit, an acquisition unit configured to acquire an average speed of the motor during conveyance of one sheet by the rotation member, and a control unit configured to determine a speed of the motor for conveying a succeeding sheet by the rotation member based on the average speed acquired by the acquisition unit at a time when a preceding sheet is conveyed by the rotation member, and control the speed of the motor based on the amount of bending detected by the detection unit during driving of the motor based on the determined speed.

Further features and aspects of the present invention will become apparent from the following detailed description of exemplary embodiments with reference to the attached drawings.

### BRIEF DESCRIPTION OF THE DRAWINGS

FIG. 1 is a sectional view illustrating an image forming apparatus.

FIG. 2 is a sectional view illustrating a portion between a transfer unit and a fixing unit.

FIG. 3 is a control block diagram illustrating the image forming apparatus.

FIG. 4 is a flowchart illustrating control of the bending amount of a transfer material between the transfer unit and the fixing unit.

FIG. 5 is a diagram illustrating a predicted value calculation table of an average conveying speed of the transfer material.

FIG. 6 is a diagram illustrating speed control based on the amount of bending.

FIG. 7 is a diagram illustrating a relationship between the bending amount of the transfer material and a state of a loop sensor.

FIGS. 8A to 8C are diagrams illustrating problems of conventional speed control.

### DESCRIPTION OF THE EMBODIMENTS

Various exemplary embodiments, features, and aspects of the invention will be described in detail below with reference to the drawings.

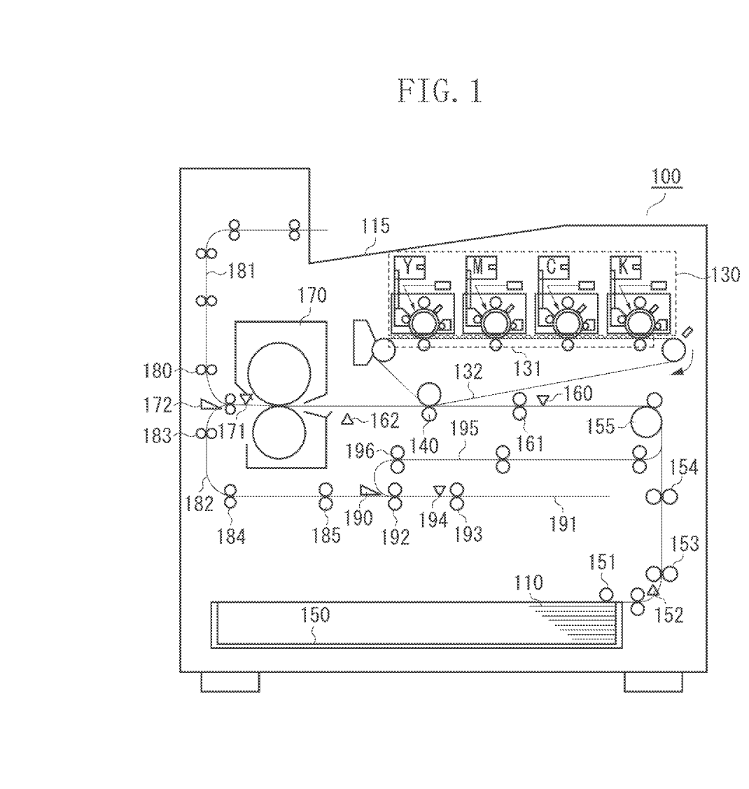

An image forming apparatus according to the present invention will be described. Referring to FIG. 1, a basic image forming operation of an image forming apparatus 100 will be described.

First, a transfer material (also referred to as sheet) 110 stored in a cassette 150 is conveyed by a sheet feeding pickup roller 151 and conveyance rollers 153, 154, and 155. In this case, whether picking-up and conveyance of the transfer material 110 has been normally carried out is monitored by using a sheet feeding sensor 152 and a conveyance sensor 160.

At timing that the transfer material 110 reaches a secondary transfer unit 140, a process unit 130 forms an image. The process unit 130 includes a photosensitive drum, a developing device, a charging roller, a photosensitive drum cleaner, and a laser scanner unit. By this process unit 130, a toner image is formed on the photosensitive drum in known electrophotography. The toner image on the photosensitive drum is transferred to a belt-like intermediate transfer body 132 by operating a known primary transfer unit 131.

Then, the toner image on the intermediate transfer body 132 is transferred to the currently conveyed transfer material 110 by the secondary transfer unit 140. To transfer the toner image to an appropriate position of the transfer material 110, timing that a leading end of the transfer material 110 reaches to the conveyance sensor 160 is monitored by using the conveyance sensor 160, and a conveying speed or a temporary stop period of conveyance, of the transfer material 110 is adjusted.

The transfer material 110 is conveyed to a fixing unit 170, and bending amount control described below is performed by using a loop sensor 162 disposed between the secondary transfer material 140 and the fixing unit 170. At this time, the transfer material is conveyed to the fixing unit 170 in a state where the appropriate amount of bending is maintained.

Then, the toner image on the transfer material 110 is heated and pressed by the fixing unit 170 to be fixed on the transfer material 110. The fixing unit 170 in the present exemplary embodiment employs a known film heating method. Whether conveyance of the transfer material 110 has been normally carried out is monitored by a conveyance sensor 171.

A flapper 172 switches the conveyance destination of the transfer material 110 with the toner image fixed by the fixing unit 170, to convey the transfer material 110 to a sheet discharge conveyance path 181 or a two-sided conveyance path 182. When a conveyance destination switched by the flapper 172 is the sheet discharge conveyance path 181, the transfer material 110 is discharged to a sheet discharge tray 115 by a sheet discharge conveyance roller 180. When the conveyance destination switched by the flapper 172 is the two-sided conveyance path 182, the transfer material 110 is conveyed to a two-sided reversing conveyance path 191 by two-sided conveyance rollers 183, 184, and 185 and two-sided reversing rollers 192 and 193. In this case, a flapper 190 switches the conveyance destination such that the transfer material 110 can be conveyed to the reversing conveyance path 191. A position of the transfer material 110 is monitored by using a two-sided reversing sensor 194, and the transfer material 110 is temporarily stopped at a predetermined position.

After the transfer material 110 has stopped, the conveyance destination of the transfer material is switched to a two-sided sheet refeeding conveyance path 195 by the two-sided reversing flapper 190. The two-sided reversing rollers 192 and 193 are driven in a reverse direction to convey the transfer material 110 to the two-sided sheet refeeding conveyance path 195. The transfer material 110 is conveyed to a conveyance roller 161 on the downstream side by a two-sided sheet refeeding roller 196 and the conveyance roller 155. Thereafter, the aforementioned transfer and fixing are performed to discharge the transfer material 110 to the sheet discharge tray 115.

The aforementioned basic image forming is only an example, and the present invention is not limited to the above-described configuration.

Next, control during the conveyance of the transfer material from the secondary transfer unit 140 to the fixing unit 170 will be described.

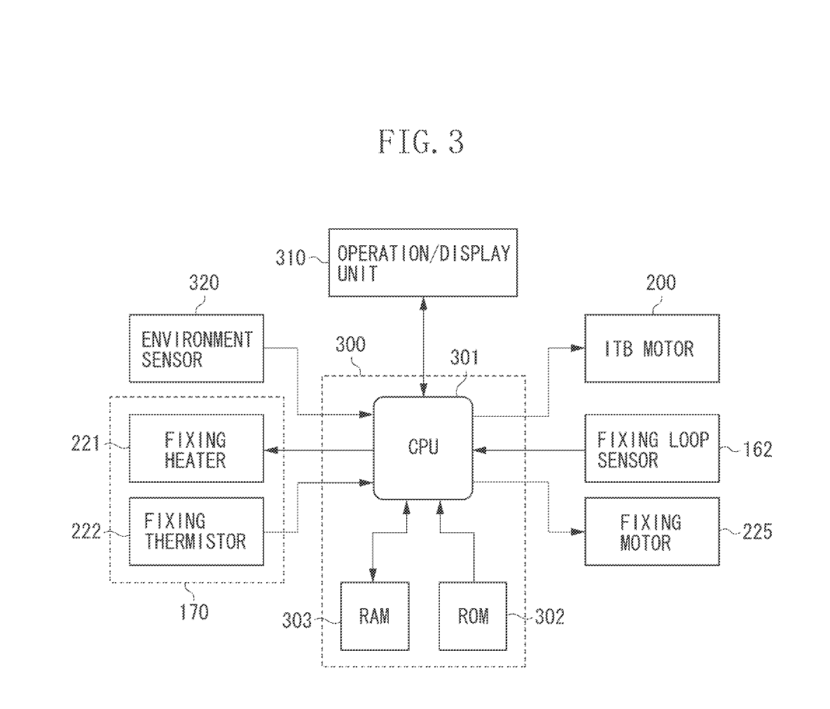

The intermediate transfer body 132 is conveyed at a constant speed in an arrow direction A by a secondary transfer opposite roller 201 driven by an intermediate transmission block (ITB) motor 200 illustrated in FIG. 3. The transfer material 110 is nipped between the intermediate transfer body 132 and a secondary transfer roller 202 driven by the secondary transfer opposite roller 201 to be conveyed to the fixing unit 170.

While the transfer material 110 is conveyed by both the secondary transfer unit 140 and the fixing unit 170, a conveying speed of the fixing unit 170 is controlled by the loop sensor 162 to adjust the bending amount of the transfer material. Control of the bending amount will be described below. Through the conveying speed control of the fixing unit 170, the transfer material is conveyed in a state where the bending amount of the transfer material is appropriately maintained.

The optical loop sensor 162 includes a light emission unit and a light reception unit, and determines whether a loop sensor flag 210 serving as a rotating moving member has blocked light from the light emission unit. When the transfer material 110 bends by a predetermined amount or more, the transfer material 110 contacts the loop sensor flag 210, and the loop sensor 210 moves to a position at which the light from the light emission unit is not blocked. In other words, the loop sensor 162 and the loop sensor flag 210 function as detection units configured to detect the bending amount of the transfer material.

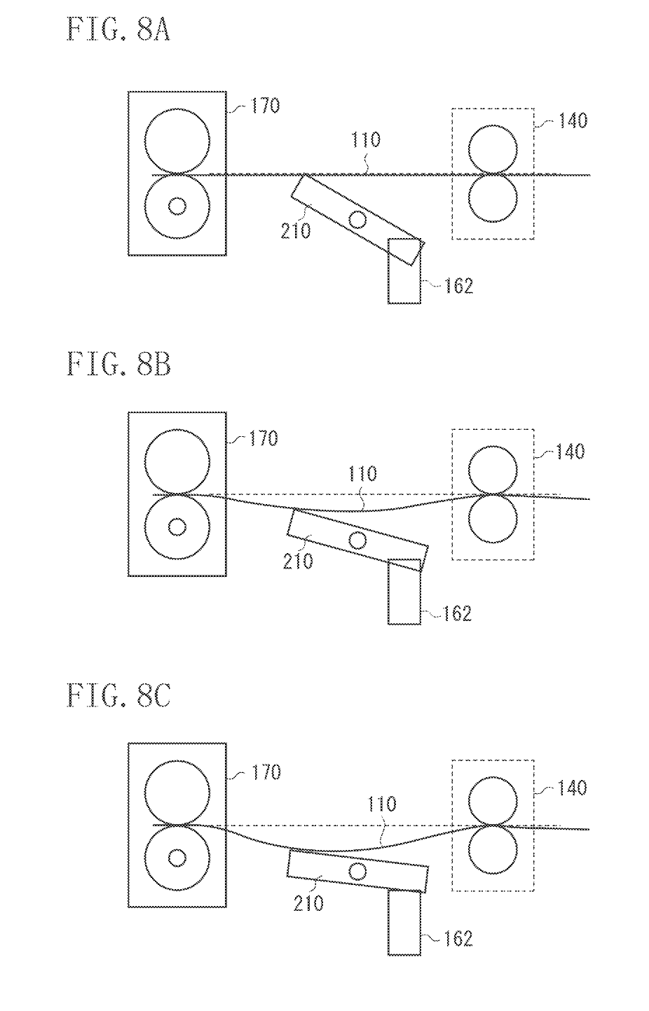

FIGS. 8A to 8C are diagrams each illustrating a bending amount of the transfer material 110 and a state of the loop sensor flag 210: FIG. 8A illustrating a case where the amount of bending is 0, FIG. 8B illustrating a case where the amount of bending is appropriate, and FIG. 8C illustrating a case where the amount of bending is larger than an appropriate amount.

As illustrated in FIG. 8A, when the amount of bending is 0 between the fixing unit 170 and the secondary transfer unit 140, the loop sensor flag 210 stops at a position where it can surely block light from the loop sensor 162. Accordingly, the loop sensor 16 comes into an OFF state. As illustrated in FIG. 8B, when the amount of bending is appropriate between the fixing unit 170 and the secondary transfer unit 140, the loop sensor flag 210 is pushed downward by the transfer material 110 to decrease in inclination. As a result, the loop sensor 162 is in a state where the loop sensor flag 210 slightly blocks light. In this case, similarly, the loop sensor 16 comes into an OFF state. As illustrated in FIG. 8C, when the amount of bending is larger than the appropriate amount between the fixing unit 170 and the secondary transfer unit 140, the loop sensor flag 210 is greatly pushed downward by the transfer material 110 to further decrease in inclination. The loop sensor flag 210 is in a transmissive state without blocking light from the loop sensor 162. Thus, the loop sensor 162 comes into an ON state.

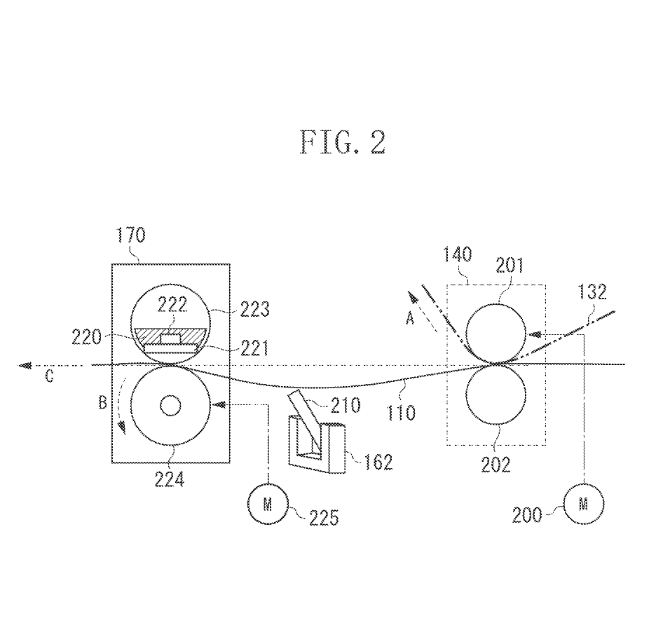

Referring to FIG. 2, the fixing unit 170 will be described. A stay 220, which has a function of holding a fixing heater and a function of guiding rotation of a fixing film 223 from the inside, is a heat resisting and heat insulating rigid body. The stay 220 is a horizontally-long member in which a direction of crossing the conveyance path of the transfer material 110 (direction orthogonal to the conveying direction) is a longitudinal direction. A fixing heater 221 made of ceramics is held along the longitudinal direction of the stay 220.

A fixing thermistor 222, which is a sensor installed in a rear surface of the fixing heater 221 and configured to detect a temperature of the fixing heater 221, functions as a fixing temperature measurement unit. Power supplied to the fixing heater 221 is adjusted based on the temperature detected by the fixing thermistor 222 to thereby enable fixing temperature control. The fixing film 223, which is a rotating member made of a cylindrical heat resisting film material, is loosely fitted around the stay 220. The fixing film 223 may be referred to as a fixing sleeve.

A pressure roller 224, which is a rotating member pressed into contact with the fixing sleeve 223, is driven to rotate by a fixing motor 225 at a predetermined circumferential speed in an arrow direction B. The fixing sleeve 223 rotates following the rotation of the pressure roller 224. The transfer material 110, which has been nipped in a fixing nip formed between the pressure roller 224 and the fixing sleeve 223, is nipped and conveyed integrally with the fixing sleeve 223. Accordingly, heat of the fixing heater 221 is applied to an unfixed image on the transfer material 110 via the fixing sleeve 223, and the unfixed image on the transfer material 110 is fixed on the transfer material 110. The transfer material 110 passed through the fixing nip is separated from the fixing sleeve 223 to be conveyed downstream. An arrow C illustrated in FIG. 2 indicates a conveying direction of the transfer material 110.

FIG. 3 is a control block diagram illustrating a configuration concerning loop amount control of the image forming apparatus.

A control unit 300 includes a central processing unit (CPU) 301 that performs overall control for the image forming apparatus, a read-only memory (ROM) 302 that stores control contents of the image forming apparatus to be executed by the CPU 301, and a random access memory (RAM) 303 used as a work area necessary for controlling the image forming apparatus by the CPU 301. The CPU 301 acquires information about image formation such as a printing mode or a size of the transfer material 110 or a start instruction of image formation input from an operation/display unit 310 by an operator. The CPU 301 causes the operation/display unit 310 to display necessary information. The CPU 301 controls the fixing heater 221 such that the temperature acquired by the fixing thermistor 222 becomes a target temperature. The ITB motor 200 drives the secondary transfer opposite roller 201 that rotates the intermediate transfer body 132. The fixing motor 225 drives the pressure roller 224. An environment sensor 320 measures environment conditions (temperature and humidity) near the image forming apparatus. The CPU 301 controls the fixing motor 225 based on the detection result of the loop sensor 162, the temperature of the fixing heater 221 acquired by the fixing thermistor 222, the external temperature and humidity acquired by the environment sensor 320, and time elapsed from the end of last printing, and controls the bending amount of the transfer material.

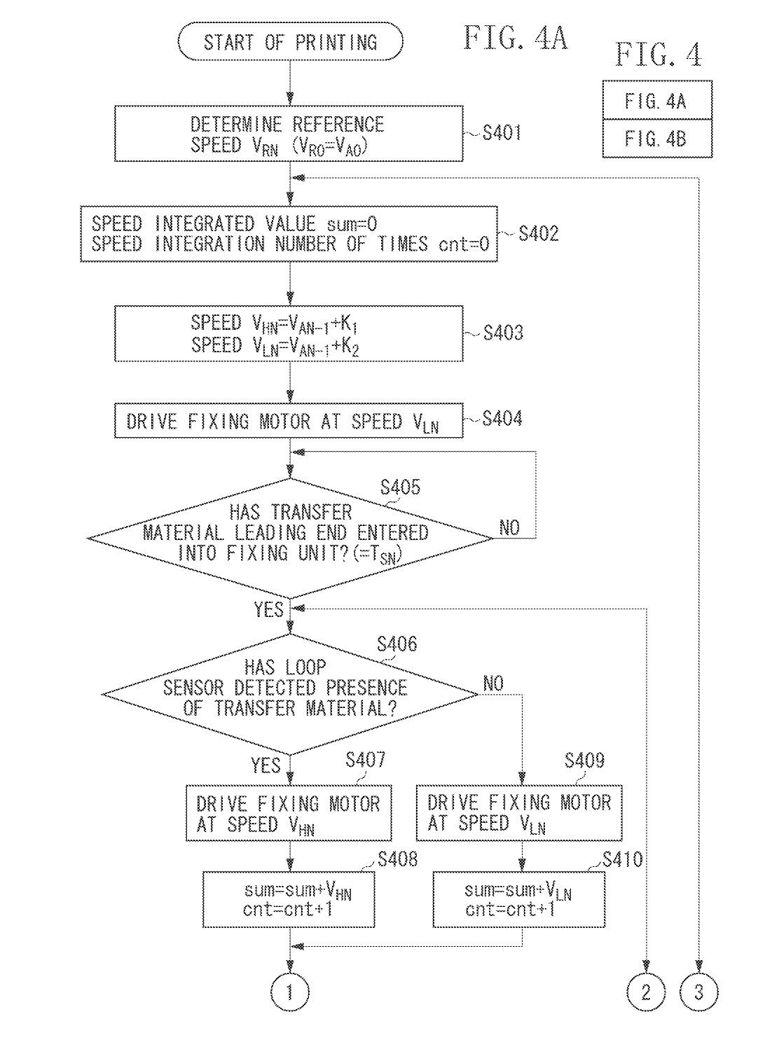

Next, conveyance control including the bending amount control of the transfer material will be described. FIG. 4 is a flowchart illustrating the conveyance control executed by the CPU 301.

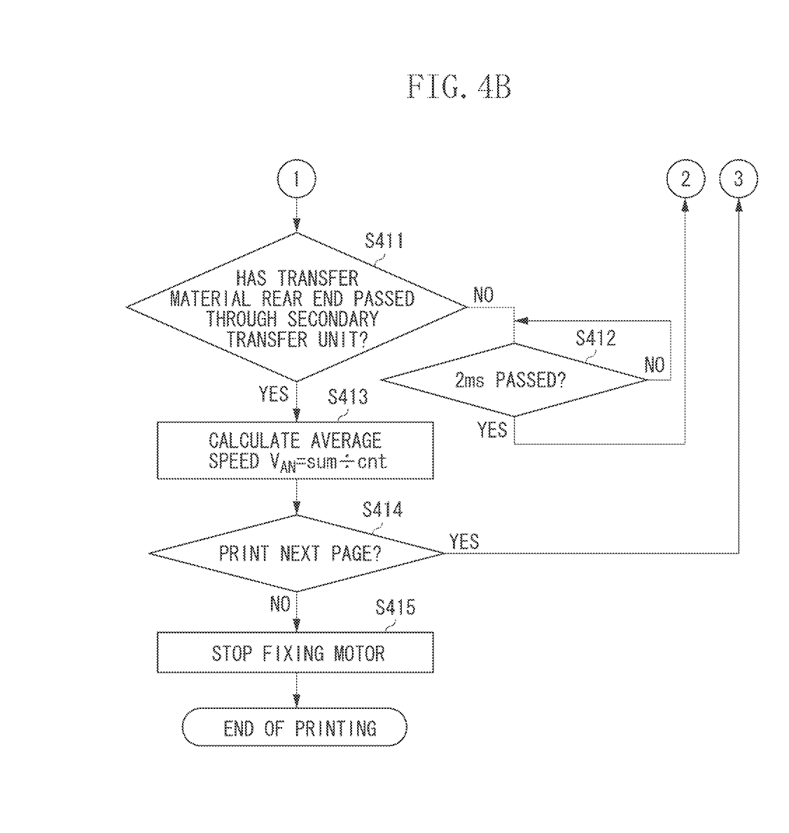

In step S401, the CPU 301 starts conveyance of the transfer material for image formation. The CPU 301 determines a reference speed V_{RN} (V_{R0}) for determining a speed of the fixing motor 225 at the time when the fixing unit 170 conveys a first transfer material. N indicates a page of the transfer material conveyed to the fixing unit 170. The reference speed V_{RN} is determined based on an average speed V_{AN-1} of the fixing motor 225 at the time when a last preceding transfer material has been conveyed. In the present exemplary embodiment, V_{RN}=V_{AN-1} is defined. The average speed V_{AN} is acquired by averaging the speeds of the fixing motor during a period from the start of conveyance by the fixing unit 170 after the transfer material of an Nth page has entered into the fixing unit 170 to passage of a rear end of the transfer material through the secondary transfer unit 140. In other words, the average speed V_{A} is an average speed of the fixing motor 225 at the time when the transfer material 110 is nipped by both the transfer unit 140 and the fixing unit 170 to be conveyed. In step S401, the first transfer material is conveyed, and thus the reference speed V_{RN} is V_{R0} (=V_{A0}). However, the CPU 301 cannot acquire an average speed V_{A0} of the transfer material 110 of an N−1th page because of the first page of a print job. Thus, the CPU 301 refers to a table illustrated in FIG. 5 to determine an average speed V_{A0} based on a measured temperature T_{E} of the environment sensor 320, a measured temperature T_{Th} of the fixing thermistor 222 immediately before a printing start, and time t elapsed from the end of temperature adjustment (printing) of the fixing heater 221. V₁ to V₆ illustrated in FIG. 5 are setting values acquired based on a relationship between warming of the fixing pressure roller 224 and a driving speed of the fixing motor 225, and in relationships of V₁≦V₂≦V₃ and V₄≦V₅≦V₆.

In step S402, the CPU 301 sets to 0 a speed integrated value sum for average speed calculation and a sampling number of times cnt of speed integrated values. In step S403, the CPU 301 calculates a speed V_{HN} and a speed V_{LN}. A speed V_{H} and a speed V_{L} respectively are a maximum value and a minimum value of conveying speeds of the fixing motor 225 during bending amount control of one transfer material. The CPU 301 sets the speed V_{HN} higher by K₁ than the average speed V_{AN-1}, and similarly sets the speed V_{LN} lower by K₂ than the average speed V_{AN-1}. K₁ and K₂ are sufficiently smaller than a value at which no image defect occurs due to pulling or excessive bending of the transfer material and sufficiently larger than an error of the average speed V_{AN-1}. A speed of the fixing motor 225 at the time when the leading end of the transfer material 110 enters into the fixing unit 170 is set to V_{LN} lower than a conveying speed at the transfer unit 140 so as to prevent the transfer material from being set in a pulled state between transfer and fixing.

In step S404, the CPU 301 drives the fixing motor 225 at a speed V_{LN}. In step S405, the CPU 301 continues driving of the fixing motor 225 at a constant speed until the leading end of the transfer material 110 enters into the fixing unit 170. It is determined whether the leading end of the transfer material 110 has entered into the fixing unit 170, based on time elapsed from detection of the leading end of the transfer material 110 by the conveyance sensor 160.

After the leading end of the transfer material 110 has reached the fixing unit 170, the CPU 301 samples and controls the speed of the fixing motor 225. In step S406, during the control, the CPU 301 determines whether the loop sensor 162 has detected a transfer material presence state (the amount of bending is larger than a predetermined amount). When a transfer material is present (the amount of bending is larger than a predetermined amount) (YES in step S406), in step S407, the CPU 301 changes the speed of the fixing motor 225 to V_{HN}. In step S408, the CPU 301 adds V_{HN} to the speed integrated value sum to count up the integration count cnt. On the other hand, when no transfer material is present (the amount of bending is smaller than a predetermined amount) (NO in step S406), in step S409, the CPU 301 changes the speed of the fixing motor 225 to V_{LN}. In step S410, the CPU 301 adds V_{LN} to the speed integrated value sum to count up the integration count.

Then, in step S412, the CPU 301 repeats the process from step S406 for every 2 msec., until the rear end of the transfer material 110 passes through the secondary transfer unit 140 (NO in step S411). After the rear end of the transfer material 110 has passed through the secondary transfer unit 140 (YES in step S411), no conveyance force of the transfer material is applied any more by the transfer unit 140, thereby removing bending of the transfer material 110. Accordingly, the bending amount control based on the speed control of the fixing motor is ended. Whether the rear end of the transfer material 110 has passed through the secondary transfer unit 140 is determined based on time elapsed from detection of the rear end of the transfer material 110 by the conveyance sensor 160.

In step S413, after the rear end of the transfer material 110 has passed through the secondary transfer unit 140, the CPU 301 calculates an average speed V_{AN} of the fixing motor 225 at the time when the transfer material of an Nth page is conveyed in a state of being nipped by both the fixing unit 170 and the transfer unit 140. The average speed V_{AN} of the fixing motor 225 is acquired by dividing the speed integrated value sum of a speed sampling result during conveyance of the transfer material 110 by the speed integration number of times cnt.

In step S414, the CPU 301 determines whether a next page to be fixed is present. When present (YES in step S414), the CPU 301 repeats the process from step S402. In this case, the conveying speed is controlled by using the average speed V_{AN-1} acquired during the conveyance of the transfer material of a last page. On the other hand, when no transfer material of a next page to be fixed is present (NO in step S414), in step S415, the CPU 301 stops the fixing motor 255 to end the process.

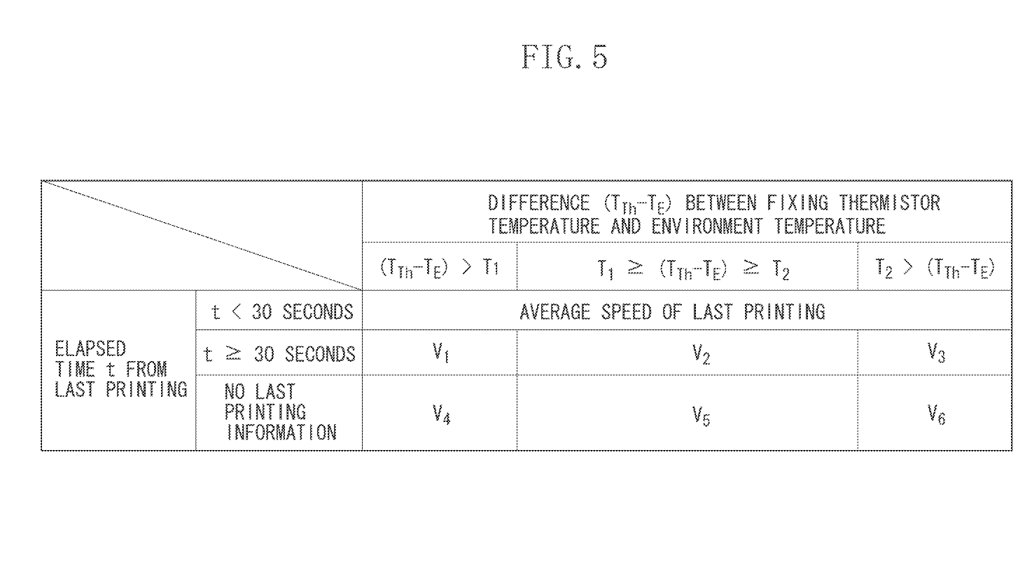

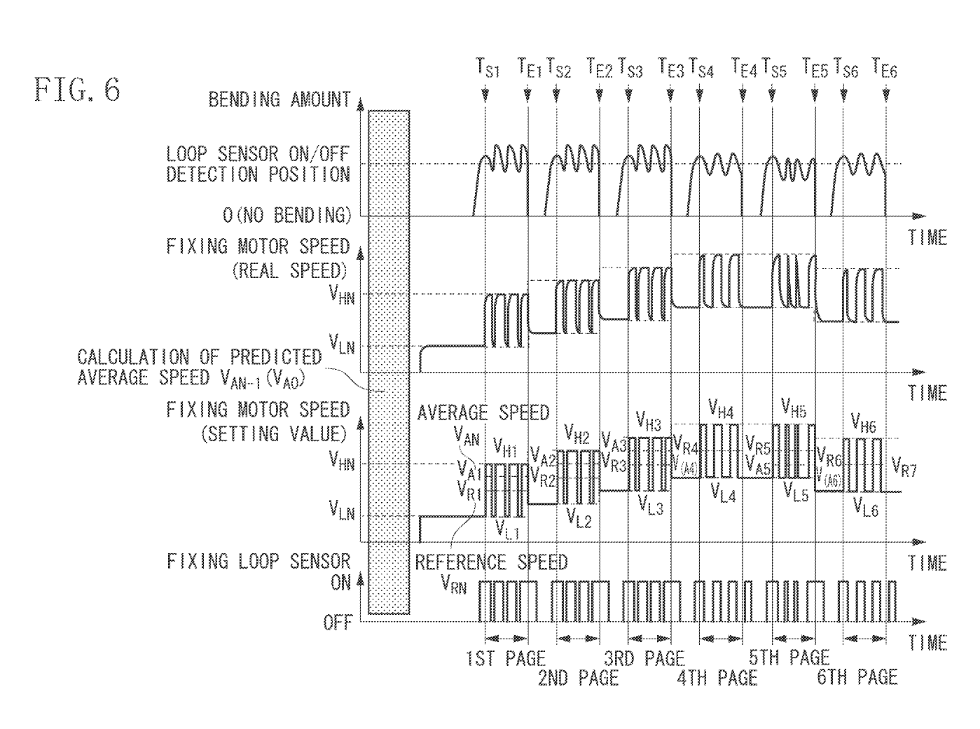

FIG. 6 is a diagram illustrating a bending amount of the transfer material, a real speed and a setting value of the fixing motor 225, and an output waveform of the fixing loop sensor 162 at the time when six pages is continuously printed.

T_{SN} (T_{S1}, T_{S2}, T_{S3}, T_{S4}, T_{S5}, T_{S6}) illustrated in FIG. 6 indicates timing at which the leading end of the transfer material 110 of the Nth page passes through the fixing unit. T_{EN} (T_{E1}, T_{E2}, T_{E3}, T_{E4}, T_{E5}, T_{E6}) indicates timing at which the rear end of the transfer material 110 of the Nth page passes through the secondary transfer unit 140. When an output of the loop sensor 162 is ON, the amount of bending is larger than a predetermined amount. When the output of the loop sensor 162 is OFF, the amount of bending is smaller than the predetermined amount. A graph of the real speed of the fixing motor indicates speed fluctuation of the fixing motor. The real speed slowly changes following the setting value of the fixing motor.

In the waveform of the fixing motor speed (setting value), an average speed V_{AN} (broken line) indicates an average speed of the fixing motor 225 at the time when the transfer material of the Nth page which is a control target is conveyed. A reference speed V_{RN} (dashed-dotted line) is a reference speed for determining a speed of the fixing motor 225 at the time when the transfer material of the Nth page which is the control target is conveyed, and equal to the average speed V_{AN-1} of a last page.

From a first to a third page, the average speed V_{AN} (V_{A1}, V_{A2}, V_{A3}) is consequently lower than the reference speed V_{RN} (V_{R1}, V_{R2}, V_{R3}). In this case, a ratio in which the loop sensor 162 is ON is high, and a ratio of setting the speed of the fixing motor 225 to V_{HN} (V_{H1}, V_{H2}, V_{H3}) is high. As a result, the reference speed V_{RN+1} (V_{R2}, V_{R3}, V_{R4}) of a next page (N+1) is set to a value higher than that of the Nth page.

In a fourth page and a sixth page, the average speed V_{AN} (V_{A4}, V_{A6}) is consequently equal to the reference speed V_{RN} (V_{R4}, V_{R6}). In this case, a ratio in which the loop sensor 162 is ON is equal to a ratio in which the loop sensor 162 is OFF, and similarly for the speed of the fixing motor, a ratio of setting V_{HN} (V_{H4}, V_{H6}) and a ratio of setting V_{LN} (V_{L4}, V_{L6}) are equal to each other. As a result, the reference speed V_{RN} (V_{R5}, V_{R7}) of a next page is set to a speed equal to that of the Nth page.

In a fifth page, compared to the pages from the first to the third, the average speed V_{AN} (V_{A5}) is consequently higher than the reference speed V_{RN} (V_{R5}). In this case, a ratio of detecting that the loop sensor 162 is OFF (the amount of bending is smaller than a predetermined amount) is high, and a ratio of setting the speed of the fixing motor 225 to V_{LN} (V_{L5}) is high. As a result, the reference speed V_{RN} (V_{R6}) of a next page is set to a value lower than that of the Nth page.

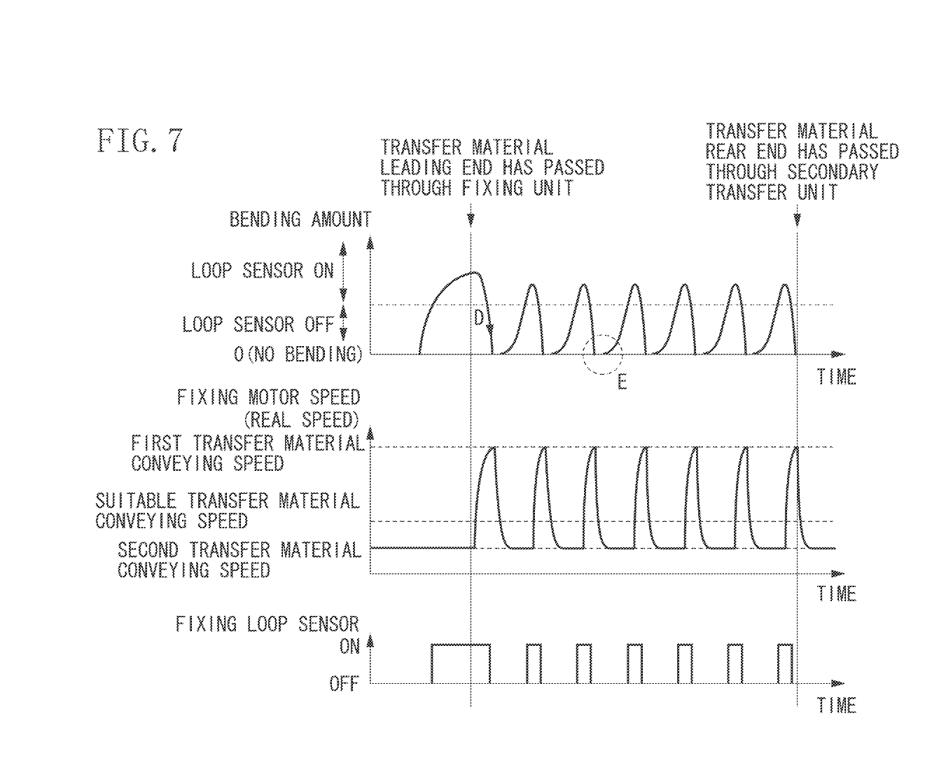

The amount of bending illustrated in FIG. 6 is smaller in vertical vibration width than that illustrated in FIG. 7. This is attributed to the reduced inclination of bending amount fluctuation caused by a smaller difference between the speed and an appropriate speed of the fixing motor 225. As a result, a phenomenon of a zero amount of bending and a phenomenon of an excessively large amount of bending are difficult to occur.

Thus, according to the present exemplary embodiment, by determining the speed of the fixing motor for conveying the next transfer material based on the average speed during conveyance of the last transfer material by the fixing unit 170, the loop amount of the transfer material can be maintained within a constant range.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-236739, filed Nov. 15, 2013, which is hereby incorporated by reference herein in its entirety.

What is claimed is:

1. An image forming apparatus comprising:
a transfer unit configured to transfer a toner image to a sheet;
a fixing unit including a rotation member and configured to convey the sheet to which the toner image has been transferred by the transfer unit, in a state of being nipped by the rotation member, and fix the toner image on the sheet;
a motor configured to rotate the rotation member;
a detection unit configured to detect an amount of bending of the sheet between the transfer unit and the fixing unit;
an acquisition unit configured to acquire an average speed of the motor during conveyance of one sheet by the rotation member; and
a control unit configured to determine a speed of the motor for conveying a succeeding sheet by the rotation member based on the average speed, acquired by the acquisition unit, at a time when a preceding sheet is conveyed by the rotation member, and control the speed of the motor based on the amount of bending detected by the detection unit during driving of the motor based on the determined speed.

2. The image forming apparatus according to claim 1, wherein the acquisition unit acquires an average speed of the motor during a period from when a leading end of the sheet reaches the rotation member, to when a rear end of the sheet passes through the transfer unit.

3. The image forming apparatus according to claim 1, wherein the detection unit detects a first state where the amount of bending of the sheet is smaller than a predetermined amount and a second state where the amount of bending of the sheet is equal to or larger than the predetermined amount.

4. The image forming apparatus according to claim 3, wherein the control unit controls the motor to increase the speed of the motor when the amount of bending detected by the detection unit changes from the first state to the second state, and decrease the speed of the motor when the amount of bending changes from the second state to the first state.

5. The image forming apparatus according to claim 4, wherein the control unit controls the motor to make the speed of the motor higher by a predetermined amount than the average speed when the amount of bending detected by the detection unit changes from the first state to the second state, and make the speed of the motor lower by a predetermined amount than the average speed when the amount of bending changes from the second state to the first state.

6. The image forming apparatus according to claim 1, wherein the control unit controls the motor to start conveyance of the succeeding sheet at a speed lower by a predetermined amount than the average speed of the motor at a time when the rotation member conveys the preceding sheet.

7. The image forming apparatus according to claim 1, wherein the detection unit includes a moving member configured to move at a time when the member contacts the bent transfer material, and a sensor configured to detect a position of the moving member.

8. The image forming apparatus according to claim 1, further comprising an environment measurement unit configured to measure a temperature near the image forming apparatus,
wherein the control unit determines a speed of the motor for conveying a first sheet of a print job based on the temperature measured by the environment measurement unit.

9. The image forming apparatus according to claim 8, further comprising a fixing temperature measurement unit configured to measure a temperature of the fixing unit,
wherein the control unit determines the speed of the motor for conveying the first sheet based on the temperature measured by the environment measurement unit, the temperature measured by the fixing temperature measurement unit, and time elapsed from last printing.

10. The image forming apparatus according to claim 1, wherein the control unit determines a first speed which is lower by a predetermined amount than the average speed acquired by the acquisition unit at a time when the rotation member conveys the preceding sheet, and a second speed which is higher by the predetermined amount than the average speed, as a lower limit speed and an upper limit speed of the motor respectively at a time when the succeeding sheet is conveyed.

11. The image forming apparatus according to claim 8, wherein the control unit determines the speed of the motor for conveying the first sheet based on a first predetermined speed when a difference between the temperature measured by the environment measurement unit and the temperature measured by the fixing temperature measurement unit is a first temperature difference, and determines the speed of the motor for conveying the first sheet based on a second predetermined speed which is higher than the first predetermined speed when the difference between the temperature measured by the environment measurement unit and the temperature measured by the fixing temperature measurement unit is a second temperature difference which is smaller than the first temperature difference.
